(19) United States
(12) Patent Application Publication
(10) Pub. No.: US 2016/0020022 A1
(43) Pub. Date: Jan. 21, 2016

(54) Wire Winding Machine

(71) Applicant: Gainteam Holdings Limited, New Territories (HK)

(72) Inventors: Wan Hong BAO, Guangdong (CN); Zhen Qi LI, Henan (CN); Hua Han ZHAI, Jiangxi (CN); Shi Biao LIU, Hunan (CN); Yi CAO, Hunan (CN); Zhi Yong TONG, Fujian (CN); Jin Bi SUN, Hubei (CN); Howard Ho Yin CHAN, Hong Kong (HK); Chung Yin AU, Prince Edward (HK)

(21) Appl. No.: 14/336,019

(22) Filed: Jul. 21, 2014

(51) Int. Cl. H01F 41/06; B65H 54/02

(52) U.S. Cl. CPC H01F 41/0625; B65H 54/02

(57) ABSTRACT

A wire winding machine (100) is disclosed which includes holders (106, 108) for holding a workpiece having a body (104a) with a hole (104b). A wire manipulator includes wire holders (116a, 116b, 116c) which are adapted for moving a piece of wire through the hole of the workpiece to form turns of winding of the piece of wire on the body of the workpiece.

### TECHNICAL FIELD

This invention relates to a wire winding machine, and, in particular, such a machine for forming winding of wire on a body of a workpiece.

### BACKGROUND

In the production of small-sized transformers, for example for use in pacemakers to be installed within a human body, windings of wires have to be formed around a core of a very small size. In the case of small-sized transformers with toroidal cores, the difficulty is more pronounced because of the necessity of winding wire through the centre hole of the torus. The production of small-sized transformers with toroidal cores is thus highly labour-intensive and not readily susceptible to automation. The production rate of such small-sized transformers is thus limited.

### SUMMARY OF THE INVENTION

It is thus an object of the present invention to provide a wire winding machine to provide a wire winding machine in which the aforesaid shortcomings are mitigated or at least to provide a useful alternative to the trade and public.

According to a the present invention, there is provided a wire winding machine including means for holding a workpiece having a body with a hole, and means for moving a piece of wire through said hole of said workpiece to form at least one turn of winding of said piece of wire on said body of said workpiece.

### BRIEF DESCRIPTION OF THE DRAWINGS

A wire winding machine and wire winding machine assemblies according to the present invention will now be described, by way of examples only, with reference to the accompany drawings, in which:

FIG. 1 is a front perspective view of a wire winding machine according to an embodiment of the present invention;

FIG. 2 is a rear perspective view of the wire winding machine of FIG. 1;

FIG. 3 is a perspective view of a wire winding machine assembly, formed of a number of the wire winding machines of FIG. 1;

FIG. 4 is a bottom view of the wire winding machine assembly of FIG. 3;

FIG. 5 is a front perspective view of a further wire winding machine assembly, formed of a number of the wire winding machines of FIG. 1; and

FIG. 6 is a rear perspective view of the wire winding machine assembly of FIG. 5.

### DETAILED DESCRIPTION OF THE INVENTION

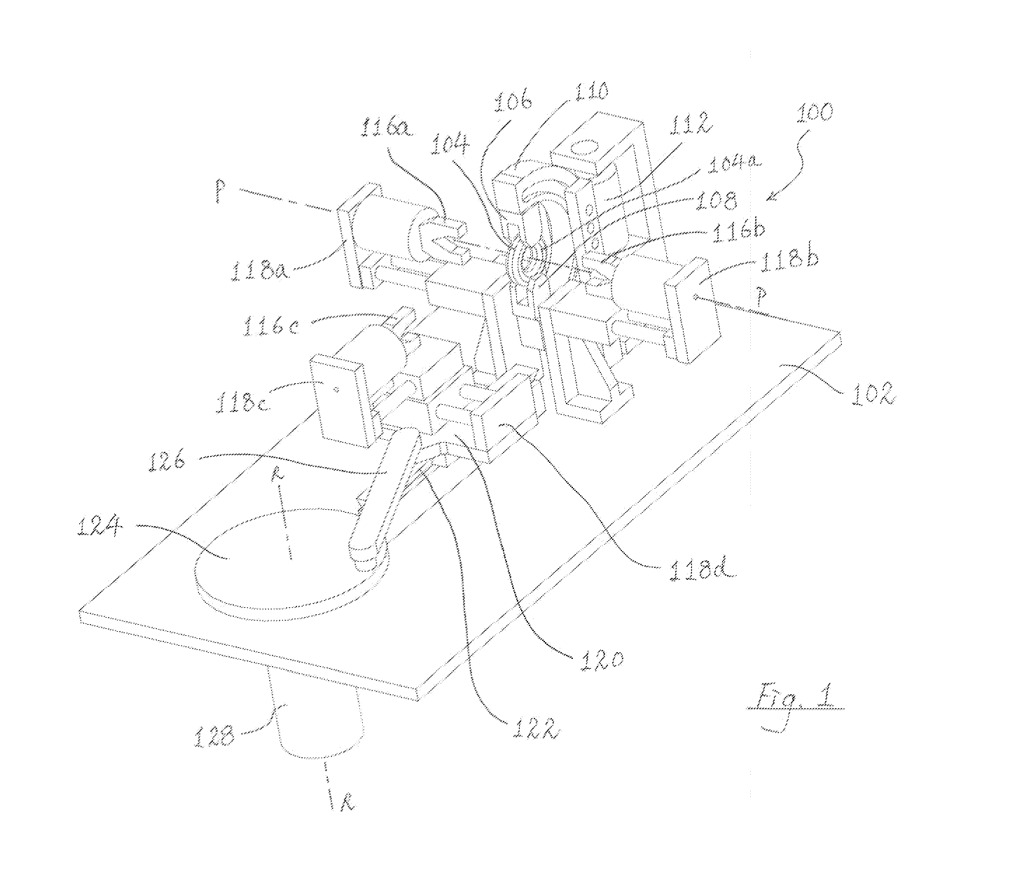

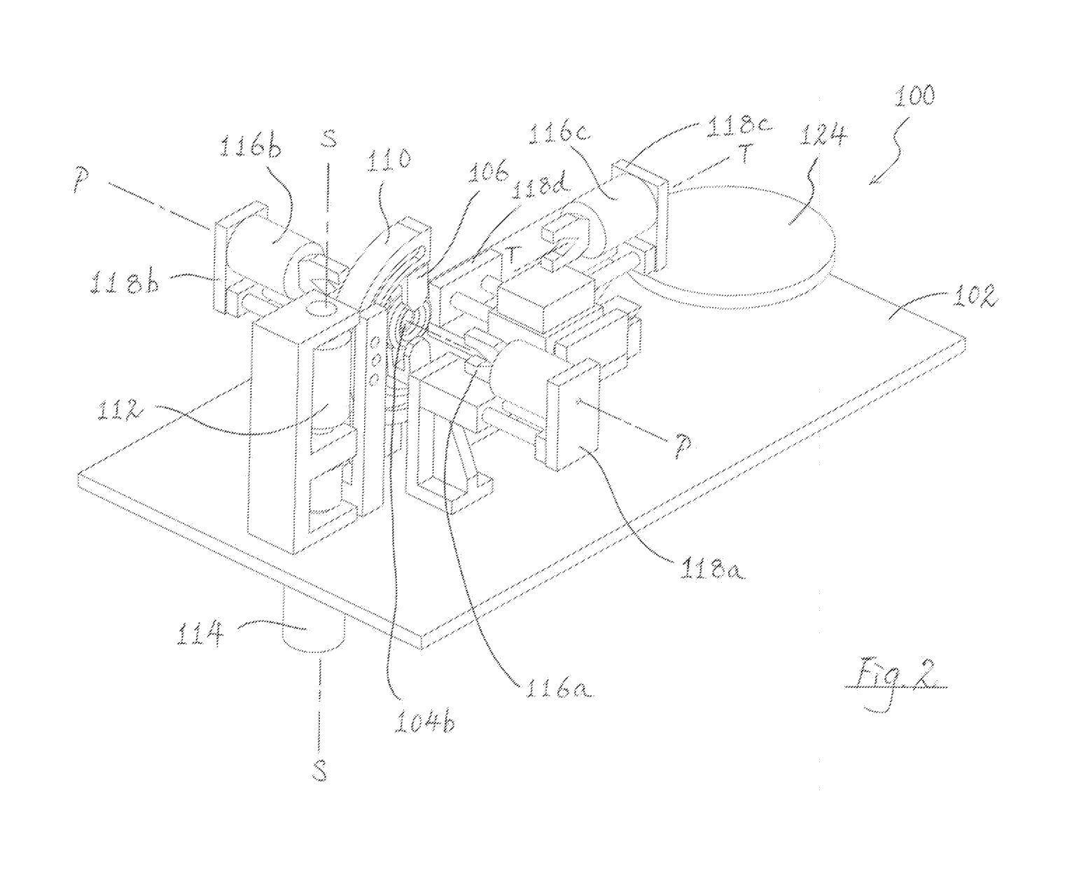

A wire winding machine according to an embodiment of the present invention is shown in FIGS. 1 and 2, generally designated as 100. The machine 100 is supported by a base 102. A toroidal core 104 (being a workpiece on and around which a piece wire is to be wound) with an annular body 104a and a central hole 104b is held from above by an upper holder 106 and from below by a lower holder 108. Two diametrically opposite parts of the core 104 are thus held by the upper holder 106 and the lower holder 108. The upper holder 106 and the lower holder 108 are fixedly engaged with a semi-circular gear ring 110 at diametrically opposite positions, for simultaneous rotational movement about an axis P-P which coincides with the central longitudinal axis of the core 104 when held by the upper holder 106 and lower holder 108. The semi-circular gear ring 110 is in mesh with a worm 112 which is rotatable about its own central longitudinal axis S-S, which is perpendicular to the axis P-P. A motor 114 is operable to drive the worm 112 to rotate about the axis S-S to thereby cause the semi-circular gear ring 110 to rotate about the axis P-P, to cause corresponding rotation of the toroidal core 104 held by the upper holder 106 and the lower holder 108, and about the axis P-P.

The machine 100 further includes a first wire manipulator 116a, a second wire manipulator 116b and a third wire manipulator 116c. The first wire manipulator 116a is movable by a first pneumatic or fluid cylinder 118a to reciprocate along a path parallel to the axis P-P; and the second wire manipulator 116b is movable by a second pneumatic or fluid cylinder 118b to reciprocate along a path parallel to the axis P-P. The path along which the first wire manipulator 116a is movable coincides with the path along which the second wire manipulator 116b is movable. The third wire manipulator 116c is movable by a third pneumatic or fluid cylinder 118c and a fourth pneumatic or fluid cylinder 118d. The third wire manipulator 116c is movable by the third cylinder 118c to reciprocate along a path parallel to an axis T-T which is perpendicular to both the axis P-P and the axis S-S, and is movable by the fourth cylinder 118d to reciprocate along a path parallel to the axis P-P.

Both the third cylinder 118c and the fourth cylinder 118d are fixed to a board 120 which is slidable along a rail 122 fixed to the base 102. The board 120 is linked with a rotary plate 124 via a link 126 eccentrically connected with the rotary plate 122. The rotary plate 122 is operatively associated with a motor 128, such that activation of the motor 128 will cause the rotary plate 122 to rotate about its central longitudinal axis R-R, which is parallel to the axis S-S. Rotation of the rotary plate 122 about the axis R-R will bring about linear movement of the board 120 (and thus the third wire manipulator 116c, the third cylinder 118c and the fourth cylinder 118d carried by it) along the rail 122, towards or away from the worm 112, depending on the direction of rotation of the motor 128.

To wind turns of a piece wire around the annular body 104a of the toroidal core 104, a piece of wire is first held by the first wire manipulator 116a when at its original rear position. The first wire manipulator 116a is then moved by the first cylinder 118a to approach the core 104 from one side, along a path parallel to the axis P-P until the first wire manipulator 116a is at its front position in which the piece of wire is received through the central hole 104b of the core 104. The second wire manipulator 116b is then moved by the second cylinder 118b along a path along an axis parallel to the axis P-P from its original rear position towards and from the other side of the core 104 to a front position to receive the wire from the first wire manipulator 116a. The first wire manipulator 116a is then moved back by the first cylinder 118a to its original rear position. The second wire manipulator 116b is then moved back, with the wire held by it, to its original rear position by the second cylinder 118b.

The third wire manipulator 116c is then moved by the third cylinder 118c and fourth cylinder 118d towards the second wire manipulator 116b to receive the wire from the second wire manipulator 116b, and is then moved by the third cylinder 118c and fourth cylinder 118d towards the first wire manipulator 116a to pass the wire to the first wire manipulator 116a. If necessary, the motor 128 rotates the rotary plate 124 to move the board 120, which carries the third wire manipulator 116c, towards or away from the worm 112, so as to maintain the wire in a taut condition when being transferred by the third wire manipulator 116c from the second wire manipulator 116b to the first wire manipulator 116a.

The above actions bring about the winding of one turn of wire on and around the annular body 104a of the core 104. After this, the semi-circular gear ring 110 is caused by the worm 112 to rotate by a pre-determined angle about the axis P-P, to bring about corresponding rotation of the core 104 about the axis P-P by the same angle. A further turn of winding of the wire may thus be formed on and around the annular body 104a of the core 104 (next to the first turn of winding of the wire just formed on and around the body 104a) by repeating the above sequence of actions, through passing of the piece of wire by and from the first wire manipulator 116a to the second wire manipulator 116b, then to the third wire manipulator 116c, and then back to the first wire manipulator 116a, to be followed by further rotation of the core 104 in the same direction by the same pre-determined angle.

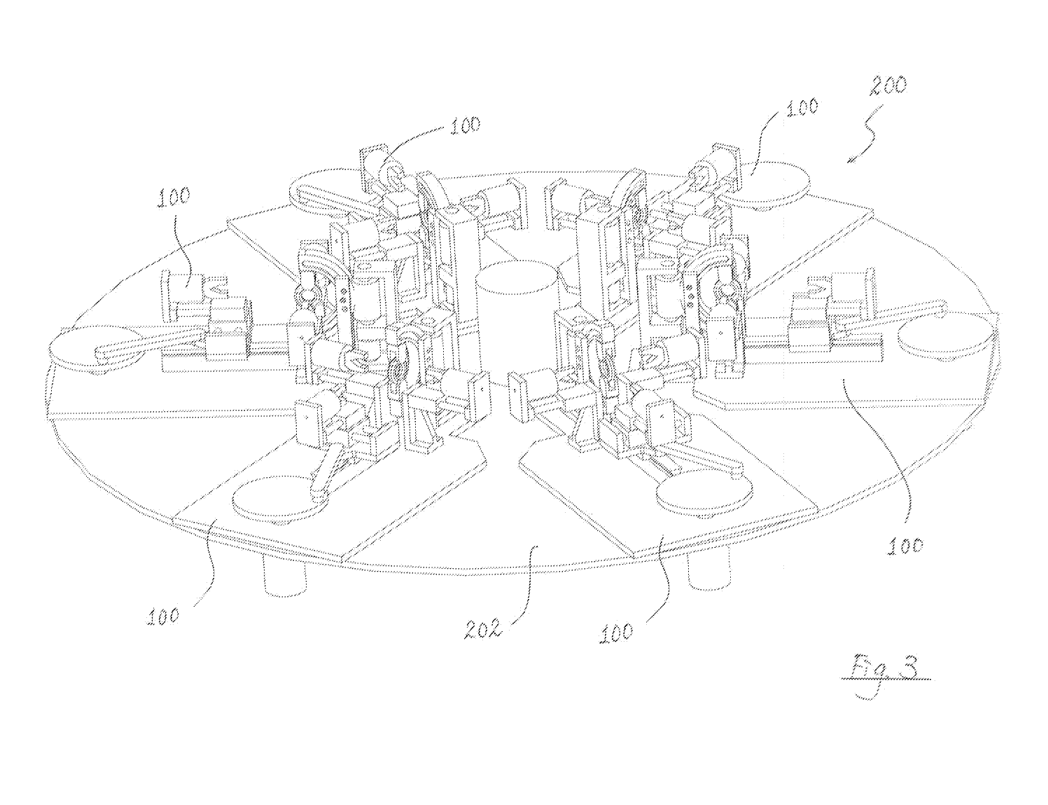

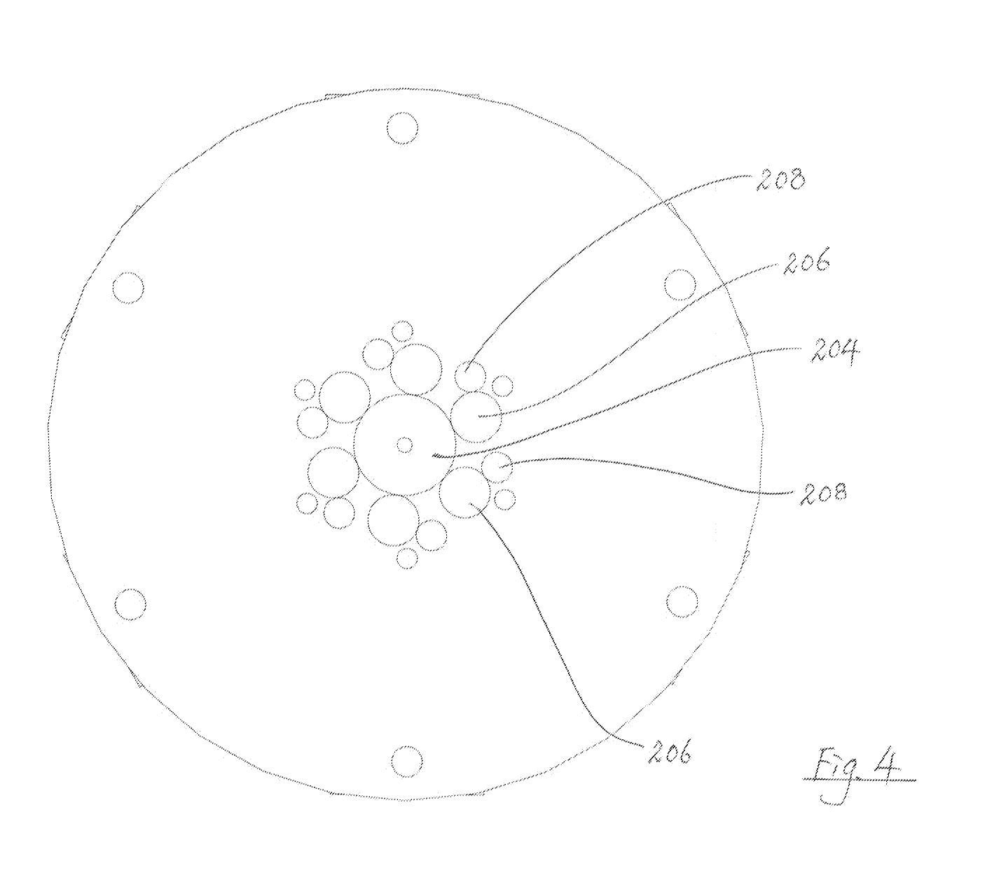

A wire winding machine assembly formed of a number of wire winding machines 100 is shown in FIG. 3, and generally designated as 200. In particular, the assembly 200 includes six wire winding machines 100 radially and equi-angularly arranged on a circular base 202. To facilitate synchronous operation of the machines 100, and as shown in FIG. 4, a central gear 204 which is operatively associated with a motor (not shown) is provided on a bottom side of the base 202. The central gear 204 is in mesh with six intermediate transfer gears 206, each in turn in mesh with a respective gear 208. Each of the gears 208 is associated with a respective worm 112 of a respective wire winding machine 100 carried by the assembly 200. By way of such an arrangement, rotation of the worms 112 (and thus that of the semi-circular gear rings 110 and the cores 104 held by the machines 100) is synchronized.

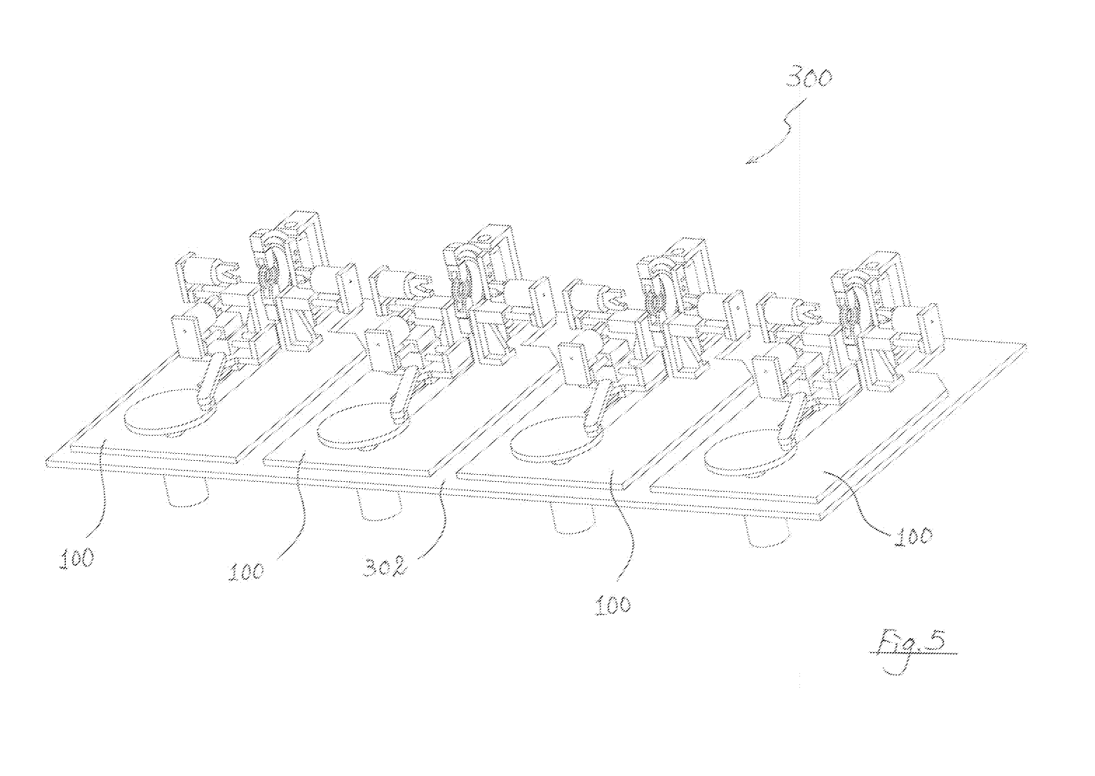

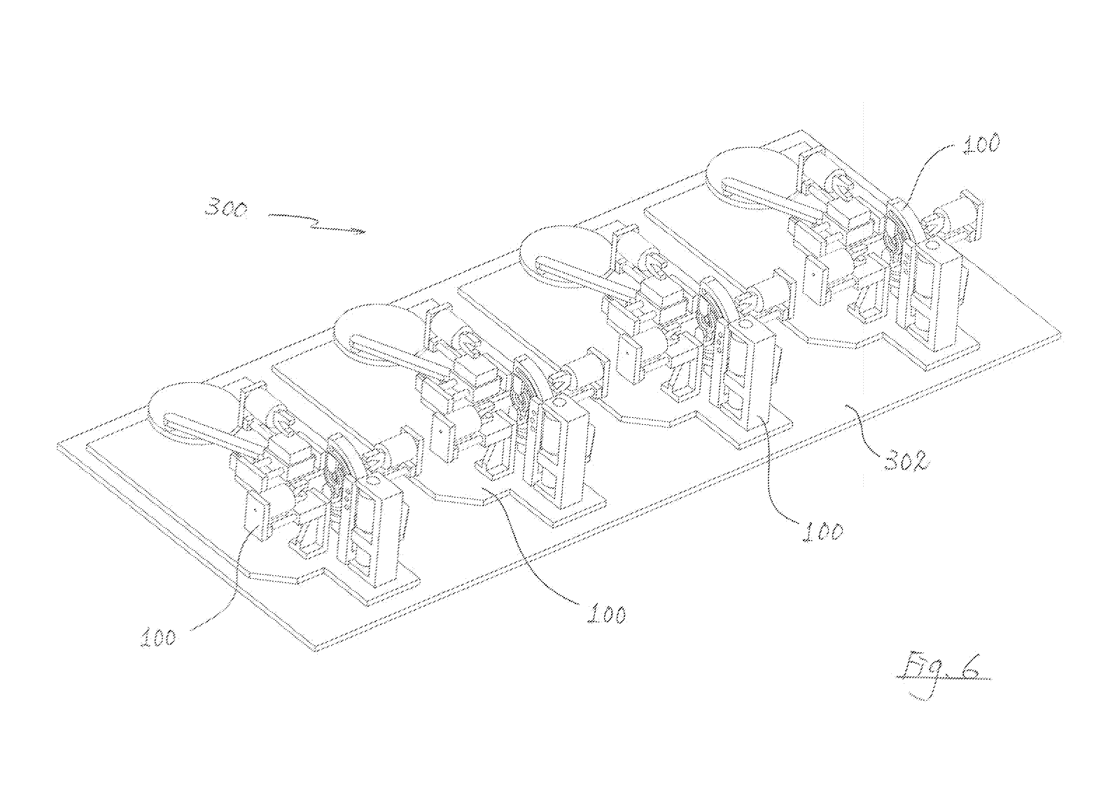

A further wire winding machine assembly formed of a number of wire winding machines 100 is shown in FIGS. 5 and 6, and generally designated as 300. In particular, the assembly 300 includes four wire winding machines 100 arranged side by side with each other on a base 302.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A wire winding machine including:
a holder for holding a workpiece having a body with a hole, and
at least one wire manipulator for moving a piece of wire through said hole of said workpiece to form at least one turn of winding of said piece of wire on said body of said workpiece.

2. The wire winding machine according to claim 1, wherein said workpiece holder is rotatable to cause said workpiece to rotate about a longitudinal axis of said workpiece.

3. The wire winding machine according to claim 2 wherein said workpiece holder is rotatable by a predetermined angle after formation of each turn of winding of said piece of wire on said body of said workpiece.

4. The wire winding machine according to claim 1 wherein said workpiece holder comprises a first workpiece holder and a second workpiece holder, each adapted to hold a respective part of said workpiece.

5. The wire winding machine according to claim 4 wherein said first workpiece holder and said second workpiece holder are adapted to hold two substantially diametrically opposite parts of said workpiece.

6. The wire winding machine according to claim 1 wherein said at least one wire manipulator includes a first movable wire holder, a second movable wire holder, and a third movable wire holder.

7. The wire winding machine according to claim 6 wherein said first movable wire holder is adapted to hold said piece of wire and to pass said piece of wire to said second movable wire holder, said second movable wire holder is adapted to receive said piece of wire from said first wire holder and to pass said piece of wire to said third movable wire holder, and said third movable wire holder is adapted to receive said piece of wire from said second movable wire holder and to pass said piece of wire to said first movable wire holder.

8. The wire winding machine according to claim 6 wherein said first movable wire holder is movable along a first axis, said second movable wire holder is movable along a second axis parallel to said first axis, and a third movable wire holder is movable along a third axis parallel to said first axis and a fourth axis perpendicular to said third axis.

9. The wire winding machine according to claim 8 wherein said first axis and said second axis substantially coincide with each other.

10. The wire winding machine according to claim 6, further comprising a device for maintaining said piece of wire taut during movement of said piece of wire from said second movable wire holder to the third movable wire holder and back to the first movable wire holder.

11. The wire winding machine according to claim 10 wherein the device is configured for moving said third movable wire holder.

12. The wire winding machine according to claim 11 wherein said device includes a rotary plate having a link operatively engaged with said third wire holder.

13. The wire winding machine according to claim 12 wherein said link is eccentrically linked with said rotary plate.

14. A wire winding machine assembly including at least two wire winding machines according to claim 1.
